(19) United States
(12) Patent Application Publication
(10) Pub. No.: US 2024/0217419 A1
(43) Pub. Date: Jul. 4, 2024

(54) MODULE SUPPORT ARRANGEMENT

(71) Applicant: Faurecia Autositze GmbH, Hannover (DE)

(72) Inventors: Piotr Ceglarek, Katowice (PL); Tomasz Stasinski, Dzierzoniow (PL); Slawomir Filip, Grabianów (PL)

(73) Assignee: Faurecia Autositze GmbH, Hannover (DE)

(21) Appl. No.: 18/397,474

(22) Filed: Dec. 27, 2023

(30) Foreign Application Priority Data
Jan. 2, 2023 (DE) 102023100028.4

(51) Int. Cl. B60N 2/90

(52) U.S. Cl. CPC B60N 2/914

(57) ABSTRACT

A module support arrangement for attachment to the seat structure of a motor vehicle seat and for fixing pneumatic components or non-pneumatic components having a module support with a front side and a rear side opposite the front side. Optionally, the module support arrangement has at least one further component, wherein the module support arrangement comprises a housing for receiving a pneumatic pump. At least one part of the housing or a plurality of parts of the housing is integrated into the module support.

### CROSS REFERENCE TO RELATED APPLICATIONS

This patent application claims priority on and the benefit of German Patent Application No. 102023100028.4 having a filing date of 2 Jan. 2023.

### BACKGROUND OF THE INVENTION

### Technical Field

The invention relates to a module support arrangement.

### Prior Art

Such module support arrangements, such as those known from EP 3 845 415 A1, are generally attached to a vehicle seat structure and are designed to fasten certain functional components, such as fluid actuators, valve blocks or pumps. In addition, the module support arrangements are also used to fasten the corresponding lines for transporting air to the individual components. As a rule, such module support arrangements are found in vehicle seats behind the seat upholstery of the backrest or seat section.

With the known systems, the functional components usually have to be attached individually to the module support. This requires fastenings for lines, valve blocks, pumps, etc. The number of components required for complete assembly, and therefore the number of components required, is relatively high with this approach.

Therefore, the object of the present invention is to create a module support arrangement, with which the required number of components is reduced compared to the prior art.

### BRIEF SUMMARY OF THE INVENTION

This object is achieved by a module support arrangement for attachment to the seat structure of a motor vehicle seat and for fixing pneumatic components or non-pneumatic components, having a module support with a front side and a rear side opposite the front side and optionally at least one further component, wherein the module support arrangement comprises a housing for receiving a pneumatic pump, wherein at least one part of the housing or a plurality of parts of the housing is/are integrated into the module support, and a vehicle seat comprising a seat frame structure and a module support arrangement, which is suspended therefrom via a suspension as taught herein. Advantageous embodiments can be found in the dependent claims.

The present invention reduces the number of components required by the fact that at least part of the pump housing is already present in the module support. Thus, a complex installation of the pump is no longer necessary and the number of components is reduced.

The module support arrangement according to the invention, which is used for attachment to the seat structure of a motor vehicle seat and for fixing pneumatic components or non-pneumatic components, has a module support with a front side and a rear side opposite the front side. Optionally, the module support arrangement has at least one further component. The module support arrangement also comprises a housing for receiving a pneumatic pump. In accordance with the invention, it is provided that at least one part of the housing or a plurality of parts of the housing is integrated into the module support.

It can be provided that the at least one part integrated into the module support is molded into the module support or formed into the module support. In this way, a highly integrative module support arrangement can be created, especially when using plastic as the starting material for the module support and the housing. In principle, the housing parts, integrated or non-integrated, for the pump can be made of the same material as the module support or of a different material. When choosing different materials, for example, the integration of a housing part on the module support using a two-component injection molding process is conceivable.

Preferably, the housing can be designed in multiple parts, wherein at least two parts are connected to one another, preferably via a hinge, an elastic connection or a living hinge. External components for completing the housing can then be connected to the part of the housing already integrated on the module support using tool-free connections, for example. If at least one part of the housing is a part that is separate from the module support, this can preferably be attached to the module support by laser welding, high-frequency welding, vibration welding, gluing, or clipping.

The material of the module support and/or the housing can be designed in different ways. According to preferred embodiments, it can be provided, among other things, that the material comprises or consists of a plastic material, a foil material, or a felt material. The support material or the module support arrangement or the housing can be a part formed by injection molding or formed by thermoforming or vacuum casting or have such a part.

Other parts can also be integrated into the module support arrangement according to the invention. Preferably, for example, it can be provided that the module support comprises integrated fastening sections for attaching or accommodating pneumatic components and/or non-pneumatic components. The pneumatic components can be selected from the following group, for example: pump, valve block, fluid actuator, fluid duct. Pneumatic bladders, which are arranged on the module support, can be used as fluid actuators. For example, a non-pneumatic component can be selected from the group comprising the following: vibration system component, ventilation system component, electrical component, wiring harness, connector, cover. The optional additional component can be a pneumatic or non-pneumatic component.

Sections can also be provided on the module support to which hose lines or fluid actuators can be fastened.

According to a further preferred embodiment of the module support arrangement according to the invention, at least one part of an air routing duct can be integrated into at least one of the parts of the housing. In this way, the insertion of hose lines can be dispensed with. This saves additional components. Preferably, such an air routing duct is then merely a connection for an external hose line or the like.

A further embodiment of the present invention provides that at least one compensator region is formed between the module support and the at least one integrated part of the housing or in the at least one integrated part, which compensator region is designed to reduce the transmission of vibrations generated by a pump received in the housing to the module support. Such a compensator region can be formed in different ways. On the one hand, it is possible, for example, to arrange material reinforcements in the material used for the module support or the integrated part of the housing at a suitable location. Another possibility is to form such a compensator region from a material that is softer than the module support or the integrated part of the housing, so that any vibrations from the pump are absorbed in this softer region and are not transmitted to the module support. This means that the entire system experiences vibration damping when the pump is in operation. Alternatively or additionally, a compensator region can also be designed in such a way that, between the surface of the module support and the motor of the pump inserted in the housing, there is an expansion space or deformation space that can compensate for deformation of the module support. At the same time, this prevents contact between the module support and the pump motor, so that the transmission of vibrations from the pump to the module support is also not possible. In principle, an embodiment is conceivable with which the intermediate space between the motor of a pump inserted in the housing and the surface of the module support has a corresponding compensator region. This can be done by leaving such intermediate space empty or by using a compensator element. For example, foam materials, rubber materials or other elastic materials can be used as compensator elements. The compensator element can be independent, i.e., designed as a separate part, or it can be a part that is attached to the module support or inserted or integrated into the module support, for example into the integrated housing part.

In principle, any suitable pump technology can be used as a pump, for example a piezoelectric pump, a pump with an actuator using dielectric elastomer (DEA), a peristaltic pump or a hose pump.

Other components can also be pre-installed on the corresponding module support in the module support arrangement according to the invention. Especially for supplying a pump or other electrical components with electrical voltage, connection parts can already be integrated into the module support. It is preferable, for example, that an electrical connecting means for electrical connection to the pump, preferably a plug or a plug interface or a cable harness, is integrated into the module support. For example, such a connecting means or an electrical supply line can be formed into the module support during production.

Finally, the invention relates to a vehicle seat that has a seat frame structure and a module support arrangement as described above, which is suspended therefrom via a suspension.

### BRIEF DESCRIPTION OF THE DRAWINGS

The invention is explained in more detail below with reference to FIGS. 1-3.

FIG. 1 shows a first perspective view of a module support arrangement according to the invention.

FIG. 2 shows a second perspective view of a module support arrangement according to the invention.

FIG. 3 shows a third perspective view of a module support arrangement according to the invention.

### DETAILED DESCRIPTION OF PREFERRED EMBODIMENTS

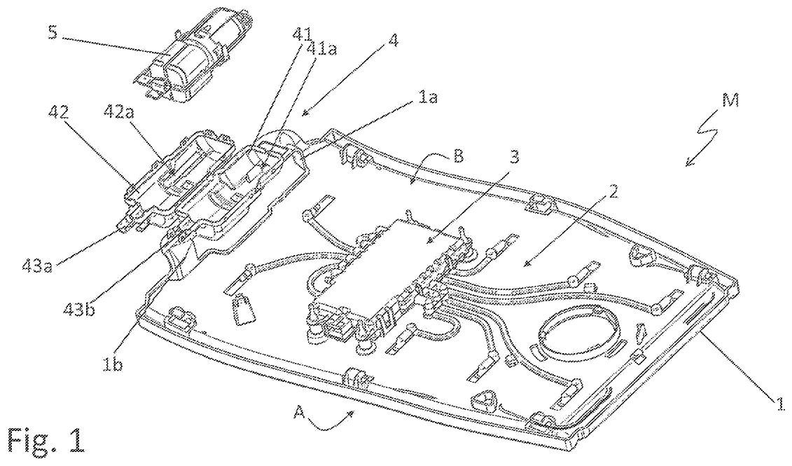

FIGS. 1 to 3 show a presentation of an exemplary structure of a module support arrangement M according to the invention.

The module support 1 has a front side A and a rear side B. As a rule, the front side A will point in the direction of travel of a vehicle seat (not shown) fitted with the module support arrangement M according to the invention. The module support 1 can then be attached to the seat frame structure of a vehicle seat via a suspension, which in the simplest case is a metal wire or the like.

The module support 1 is preferably made of a material that preferably contains plastic, a film, or felt. The module support 1 usually has air routing ducts 2 fastened to it, which are part of a pneumatic system that can include fluid actuators or other pneumatic components, for example pneumatic components, such as a valve block 3 and/or a pump 5.

In the example shown, the module support arrangement M also comprises a further component, in this case in the form of a valve block 3, which can be attached to the module support 1 and to which the air routing ducts are connected. Fluid actuators, which are preferably fluid-fillable bladders, can be connected to the air routing ducts, for example, with the aid of which a seat adjustment function or even a massage function can be realized. Such fluid actuators also form components of a pneumatic system and can be connected to air routing ducts in the module support 1 and/or the further component 3, and thus supplied with air. A seat upholstery not shown here can then be attached to the front side A above the fluid actuators.

As shown in FIGS. 1 to 3, at least one part 41 of the housing 4 having a receiving space 41a, 42a for receiving the pump 5 is part of the module support 1. Here, “part” means that it is preferably integrated into the module support. Preferably, the housing 4 is designed with two housing halves 41, 42, of which at least one housing half 41 is an integral component of the module support 1. Here, the part 41 is connected to the remaining module support 1 via the connection sections 1a, 1b. These can also be designed as compensation regions, for example by having an amplification or other damping that dampens the vibrations of the pump 5 during operation and thus does not transmit them to the rest of the module support 1.

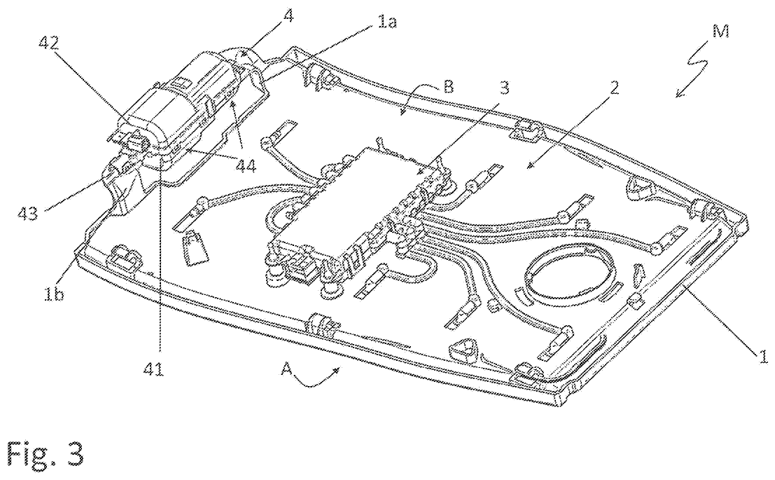

Additional compensator regions can also be provided inside 41a, 42a of individual housing parts 41, 42, which compensator regions are designed, for example, as recesses or the like and serve to prevent the direct transmission of vibrations between the pump 5 and the module support 1. The second part 42 of the housing 4 can be formed in one piece with the first part, for example via a living hinge or the like, but can also be formed as a separate component. Preferably, both housing halves 41, 42 also have feed-through sections or line sections 43a or 43b, which together form a feed-through 43 (see FIG. 3) for a supply cable of the pump 5 or the part of an air routing line.

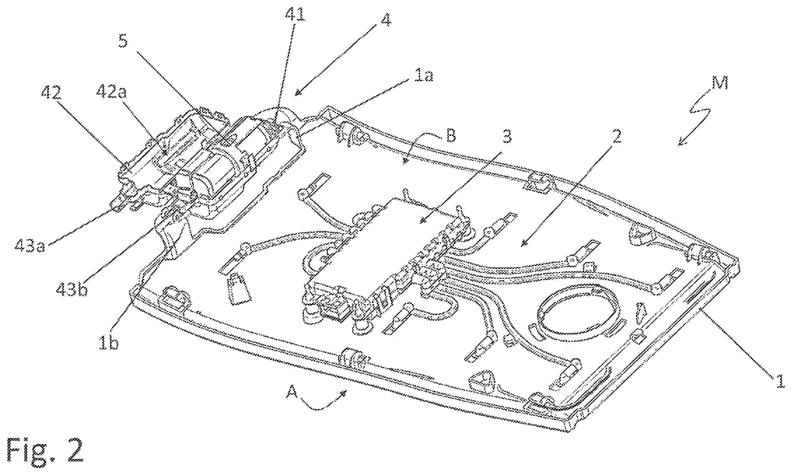

FIG. 1 shows the situation in which the housing 4 is open to receive the pump 5. With this embodiment, the pump 5 is initially inserted into one half of the housing 41, as shown in FIG. 2. Then, as shown in FIG. 3, the housing 4 is closed by placing the other half of the housing 42 over the pump 5, either by pivoting, if there is already an articulated connection between the parts 41 and 42, or by placing it on top. A fixing of the part 42 on the part 41 can be affected, for example by means of clip connections, as indicated by position 44 in FIG. 3.

The module support arrangement according to the invention thus makes it possible to integrate components of a pneumatic system, at least partially, into a module support. This allows components to be saved, as at least parts of pneumatic components are formed by the module support itself or the material of the module support.

What is claimed is:

1. A module support arrangement (M) for attachment to the seat structure of a motor vehicle seat and for fixing pneumatic components (2, 3, 5) or non-pneumatic components, having a module support (1) with a front side (A) and a rear side (B) opposite the front side (A) and optionally at least one further component (3), wherein the module support arrangement (M) comprises a housing (4) for receiving a pneumatic pump (5), wherein at least one part (41, 42) of the housing (4) or a plurality of parts (41, 42) of the housing (4) is/are integrated into the module support (1).

2. The module support arrangement (M) according to claim 1, wherein the at least one part (41, 42) integrated into the module support (1) is molded into the module support (1) or formed into the module support (1).

3. The module support arrangement (M) according to claim 1, wherein the housing (4) is designed in multiple parts, wherein at least two parts (41, 42) are connected to one another, preferably via a hinge, an elastic connection or a living hinge.

4. The module support arrangement (M) according to claim 1, wherein the module support (1) and/or the housing (4) has a material that comprises or consists of a plastic material, a foil material, or a felt material.

5. The module support arrangement (M) according to claim 1, wherein the module support (1) and/or the housing (4) is an injection-molded part or a part formed by thermoforming, blow molding or vacuum casting.

6. The module support arrangement (M) according to claim 1, wherein the pneumatic components (2, 3, 5) are selected from the group consisting of a pump (5), a valve block (3), a fluid actuator, and fluid ducts (2).

7. The module support arrangement (M) according to claim 1, wherein at least one part (42) of the housing (4) is a part which is separate from the module support (1) and which is attached to the module support (1), preferably by laser welding, high-frequency welding, vibration welding, gluing, or clipping.

8. The module support arrangement (M) according to claim 1, wherein at least one part of an air routing duct (2) is integrated into at least one of the parts (41, 42).

9. The module support arrangement (M) according to claim 2, wherein at least one compensator region is formed between the module support (1) and the at least one integrated part (41) of the housing (4) or in the at least one integrated part (41), which compensator region is designed to reduce the transmission of vibrations generated by a pump (5) received in the housing (4) to the module support (1).

10. The module support arrangement (M) according to claim 1, further comprising an electrical connecting means for electrical connection to a pump (5), preferably a plug or a plug interface or a cable harness, integrated into the module support (1).

11. A vehicle seat comprising a seat frame structure and a module support arrangement (M), which is suspended therefrom via a module support arrangement (M) for attachment to the seat structure of a motor vehicle seat and for fixing pneumatic components (2, 3, 5) or non-pneumatic components, having a module support (1) with a front side (A) and a rear side (B) opposite the front side (A) and optionally at least one further component (3), wherein the module support arrangement (M) comprises a housing (4) for receiving a pneumatic pump (5), wherein at least one part (41, 42) of the housing (4) or a plurality of parts (41, 42) of the housing (4) is/are integrated into the module support (1).
